(19) United States
(12) Patent Application Publication
(10) Pub. No.: US 2007/0005413 A1
(43) Pub. Date: Jan. 4, 2007

(54) Dynamic prioritization in a work management process

(75) Inventors: Eric J. Hennings, Seattle, WA (US); Michael D. Pinckney, Clyde Hill, WA (US)

Correspondence Address: MICROSOFT CORPORATION;ATTN: PATENT GROUP DOCKETING DEPARTMENT, ONE MICROSOFT WAY, REDMOND, WA, 98052-6399, US

(73) Assignee: Microsoft Corporation, Redmond, WA (US)

(21) Appl. No.: 11/171,051

(22) Filed: Jun. 30, 2005

(51) Int. Cl. G06F 15/02

(52) U.S. Cl. 705/9

(57) ABSTRACT

The present application describes an integrated work management and tracking framework that implements a dynamic prioritization process that identifies one or more user tasks that should be given priority by the user. The dynamic prioritization process suggests a small set of tasks or items to the user that the user should focus on and it allows the user to choose the tasks/items that the user determines to be of priority.

### BACKGROUND

The number of jobs that require management of a large amount of information have increased significantly over the last few years. In addition, such jobs have seen an exponential rise in the amount of and type of information that is required to be managed. Managing such information is more difficult, not only because of the increase in volume but because of the complex, ambiguous and changing nature of information.

Rapid growth in information sources and communication drive volume; new business models/techniques drive complexity; virtual teaming, matrix management and partnership relationships increase ambiguity. Information technologies that were non-existent a mere ten or fifteen years ago are common in a typical workplace today (e.g. email, Internet, instant messaging, etc.).

As the volume and complexity of information has increased, so has the difficulty of managing information. Users frequently have hundreds and/or thousands of tasks, to-dos, goals, projects, etc. to track and manage. This situation has been referred to as “information overload” and it makes it more difficult for the user to locate items that the user needs to focus on most.

### SUMMARY

The present disclosure describes an integrated work management and tracking framework that implements a dynamic prioritization process that identifies one or more user tasks that should be given priority by the user. The dynamic prioritization process suggests a small set of tasks or items to the user that the user should focus on and it allows the user to choose the tasks/items that the user determines to be of priority.

Tasks, goals, projects, to-dos, etc. correspond to actions which are represented by action objects that include user-defined and machine-generated attributes. Identifying tasks that should be given priority is accomplished using automatic generation of action object attributes, the application of machine-learning to determine what users will likely want to work on, iterative refinement via user interaction with suggested actions and inclusion of external factors in the machine-learning process.

With dynamic prioritization, a user may ask for suggestions as to how best spend the user's time and receive up to several suggestions based on action properties (e.g. importance, category, due date, time required to complete the action), availability of resources required to complete the action, personal criteria (effort, interest, etc.), the user's work history (e.g. user tends to work on actions the day before they are due, etc.), etc. The user can determine what he should work on based on the suggestions.

The dynamic prioritization process may also be triggered by a time slot opening up on a user's calendar. For instance, if a two-hour meeting is moved to a following week, the process may ask the user if the user wants to refill the vacated time slot. If the user wishes to do so, the user is presented with suggestions that could best utilize the time slot.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a diagram of an exemplary action object store in accordance with the present description.

FIG. 2 is a simplified illustration of a user interface having a work management framework in accordance with the present invention included therein.

FIG. 3 is a simplified illustration of the user interface of FIG. 2 and further showing creation of a new action object.

FIG. 4 is a simplified illustration of the user interface of FIG. 3 and further showing selectable collateral task items as described herein.

FIG. 5 is a simplified illustration of an exemplary user interface for dynamic prioritization of actions.

FIG. 6 is a block diagram of an exemplary computing system in accordance with the present description.

FIG. 7 is a flow diagram depicting an exemplary methodological implementation of a work tracking process.

FIG. 8 is a flow diagram depicting an exemplary methodological implementation of dynamic prioritization in a work management process.

FIG. 9 is a block diagram depicting an exemplary general purpose computing device that may be used in conjunction with one or more implementations described herein.

### DETAILED DESCRIPTION

Overview

The presently described subject matter describes dynamic prioritization of actions (i.e. tasks, goals, to-dos, projects, etc.) in a work management framework that assists information workers in focusing on goals they need to accomplish even if the goals entail tasks to be performed across a range of tools and/or applications.

Users frequently have hundreds or thousands of actions pending at any one particular time. As such, it is sometimes difficult for users to maintain a good sense of how the users can best spend their time working on these actions. In contrast to a simple calendar or to-do list that serially arranges actions in a manner configured by a user, dynamic prioritization identifies actions that best fit into a user's schedule and overall goals.

For example, if a user wants to know which action the user can work on to make the most efficient use of the user's time, the user can request the described dynamic prioritization process to determine—from a large number of actions—which actions would be best for the user to work on. The dynamic prioritization process makes such a determination based on several factors, such as action attributes, availability of resources required for the action, user work history, etc.

The dynamic prioritization process may also be initiated automatically, for example, in response to a scheduled time slot opening up. When such an opening is detected, the process may be initiated to inform the user of a few actions that the user might consider to fill in the newly vacated time slot.

The dynamic prioritization process looks at action attributes that are either assigned to an action by a user, are inherent to the action (i.e. default attributes, or are assigned to the action through a machine-learning process) and selects a small group of actions that are most suitable for a particular time slot. The suggestions are provided to the user, who then makes a final determination as to which action the user prefers to insert into the vacant time slot.

Some examples of attributes that might be taken into consideration. in this example include a “time to complete” attribute. When creating an action, a user may include an amount of time the user estimates it will take to complete the action. If the “time to complete” attribute is two hours or less, it may be considered for the vacated two-hour time slot. Anything taking more than two hours to complete would not be included.

Of course, other factors are also considered, such as importance of an action (more important actions will be considered before less important actions), time frame (actions due in the near future will be considered before actions due later), category (if, for example, there is an action in a particular category scheduled adjacent to the time slot, then actions in the same category will receive priority), personal criteria such as user interest (actions with higher user interest will be considered over actions with lower user interest), and the like.

Some of these attributes will be associated with an action by the user, such as user interest, importance, etc., while other attributes will be inherent to the actions (i.e. they are default attributes for the particular type of action). Yet other attributes may be assigned to the actions via a machine-learning process that is described herein and in greater detail below.

A primary building block of the work management framework described herein is an action (stored as an action object). An action is application independent and represents a work goal and may be thought of as a collection of files, states, processes, links, workspace, and the like, that are related to accomplishing the goal. An action object is an object that can be stored on one or more computer-readable media to retain the attributes related to an action. However, the terms “action” and “action object” can be used interchangeably depending on the context in which the term is used.

An action has several characteristics but it is basically a unit of work as defined by a user. For example, “Borrow book from Jim” is an action; “Build a new factory” is an action. An action, as viewed within the presently described framework, contains information that the user requires to accomplish the work, such as documents, messages, files, contacts, relationships, processes, etc. An action may also include a sub-action which has its own unique attributes.

Action objects are stored in a flexible configuration that allows them to have arbitrary tools, processes and/or documents/reference materials associated with them (i.e. “task items”). When an action object is associated with a task item, an extension/linking approach is used so that the task items remain embedded in their original applications and do not require multiple copies of documents, messages, etc. This also allows multiple users and/or action objects to link to the same task items.

Action objects may also be marked with attributes that allow them to be sorted, filtered, prioritized and otherwise visualized and categorized. As previously described, these attributes may be user assigned, inherent or assigned via a machine-learning process. Attributes represent characteristics of the action to which they correspond and users may create and assign attributes as they deem necessary for their particular working environment.

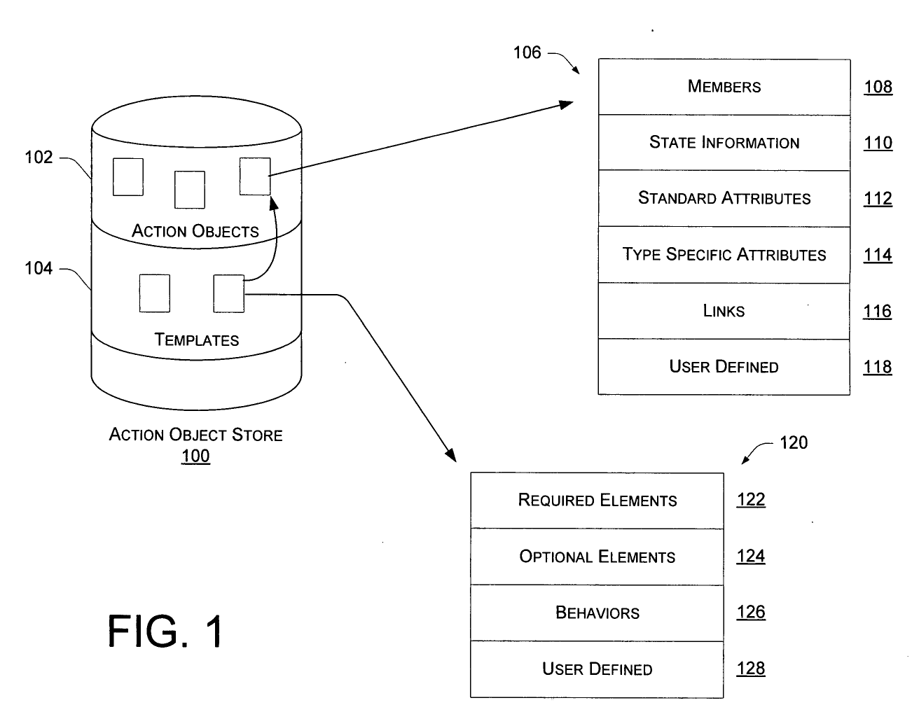

Further details of the work management system and the dynamic prioritization process associated therewith are described in greater detail below, with respect to FIGS. 1 through 9.

Exemplary Action Object Store

FIG. 1 is a diagram of an exemplary action object store 100 in accordance with the present description. The exemplary action object store 100 stores one or more action objects 102 and up to several action object templates 104.

An exemplary action object 106 is shown in greater detail and includes members 108, state information 110, standard attributes 112, type specific attributes 114, links 116 and user defined elements 118. Members 108 may include any metadata that should be associated with an action object. Such metadata may include, but is not limited to, a globally unique identifier (guid), object creation information, modification information, predecessor information (i.e. is this action object a task item in another action object?), family information and/or the like.

State information 110 is used to preserve active states that are current when the action object is saved. For example, if the user saves an action object while the user has certain tiles open and viewable on a user interface, the user interface state is saved so that when the action object is accessed again, the same user interface view can be restored to the user. Other state information may include how long the user has worked on a particular action (total time and/or session time), what applications are being used, a web site history, etc.

Standard attributes 112 represents particular attributes that are standard, i.e. that are included with all action objects. Standard attributes 412 may include attributes such as where the action object is to be stored, what work categories are or might be related, etc. Some other examples of standard attributes include but are not limited to:
Due date;
Date started;
Date completed;
Auto-expire date (i.e. “discard after Jan. 1, 2005”);
People (clients, participants, reviewers, team members, etc.);
Place(s) where action can be performed (e.g. home, store, etc.);
Goals; and
Keywords.

Type specific attributes 114 include attributes that are associated with a particular type of action object. Type specific attributes 114 may be in addition to the standard attributes 112 or may override similar standard attributes 112. For example, a standard attribute 112 may be an attribute that identifies a location to store the action object and this may generally apply to all action objects. However, when an action object is of a specific type (e.g. “Patent Application”) a type specific attribute 114 may cause action objects of a specific type to be stored in a different location (e.g. a “Patent Applications” directory) or to have change notifications automatically emailed to the inventors, patent attorneys, etc. that are associated with the patent application.

Virtually any type of attribute may be assigned by a user. Example attributes include, but are not limited to: category; time to complete; time frame (none, ASAP, this week, next week, this month, someday, due date, etc.); importance (high, average, low, critical, varying depending on other attributes, etc.); personal criteria (effort, interest, etc.); order in list (to provide ordered list support so a user can deal with independent items sequentially).

The links 116 area includes the necessary links to task items that are associated with the action object 106 and that are presented to a user when the user is viewing the action in a user interface. For example, links may include links to email messages, contacts, documents, another action object, etc. that are associated with the action object. By including links to task items instead of the task items themselves, memory is conserved and files are not duplicated. Instead, the files reside with their original application. This also causes the file to remain intact when being shared between users since users cannot alter different copies of the same file.

The user defined elements 118 provide extensibility to the action object 106 schema. Users may use the user definitions allow individual users to add customized extensions to more specifically tailor an action object to meet a particular need.

Action object templates 104 allow users to predefine certain types of action objects 102 that are suited to a function that is performed repeatedly in the course of the user's work. For example, if a user tends to deal with a lot of patent applications, the user may want to configure a “Patent Application” template that sets up some basic parameters of an action object that is used in conjunction with a patent application project.

An action object template 120 is shown in greater detail and includes a required elements section 122 and an optional elements section 124. The required elements section 122 is configurable as necessary to include elements that are included with each action object based on the action object template 120.

For example, if the action object template 106 is of a type “Patent Application,” required elements may include a pointer to a patent application document template, a pointer to an information disclosure statement (IDS) form, a pointer to a directory containing transmittal forms, and/or the like. Any task item that is considered necessary to execute an action based on the action object type should be included in the required elements section 108.

On the other hand, the optional elements section 110 is configurable to include pointers to task items selected by a user, such as by one or more of the techniques previously described. Using the example of the “Patent Application” action object template, a user may pull in pointers to inventor contacts, technical documents, disclosure documents and/or the like to the optional elements section 110 of the action object template 106. Once this is done, the user may save the action object template 106 as an action object 102 thereby leaving the original action object template 106 intact.

In addition to these sections, the action object template 106 may be configured to include behaviors 112 and/or user definitions 114. Behaviors 112 include rules that are performed when dealing with the action object. For example, an action object of type “Patent Application” may include a behavior 112 that causes an updated copy of the action object to be sent to one or more contacts (either contacts associated with the action object or contacts specified in the particular behavior) whenever the action object is changed and saved.

The user definitions 114 provide an extensible property to the action object template 106. The user definitions 114 provide extensibility to the action object 406 schema. Users may use the user definitions to allow individual users to add customized extensions to more specifically tailor an action object to meet a particular need. For example, if a user wants to be able to sort actions based on which actions can be performed at a home office, the user can add a “Do at home” attribute to the schema.

Exemplary User Interface

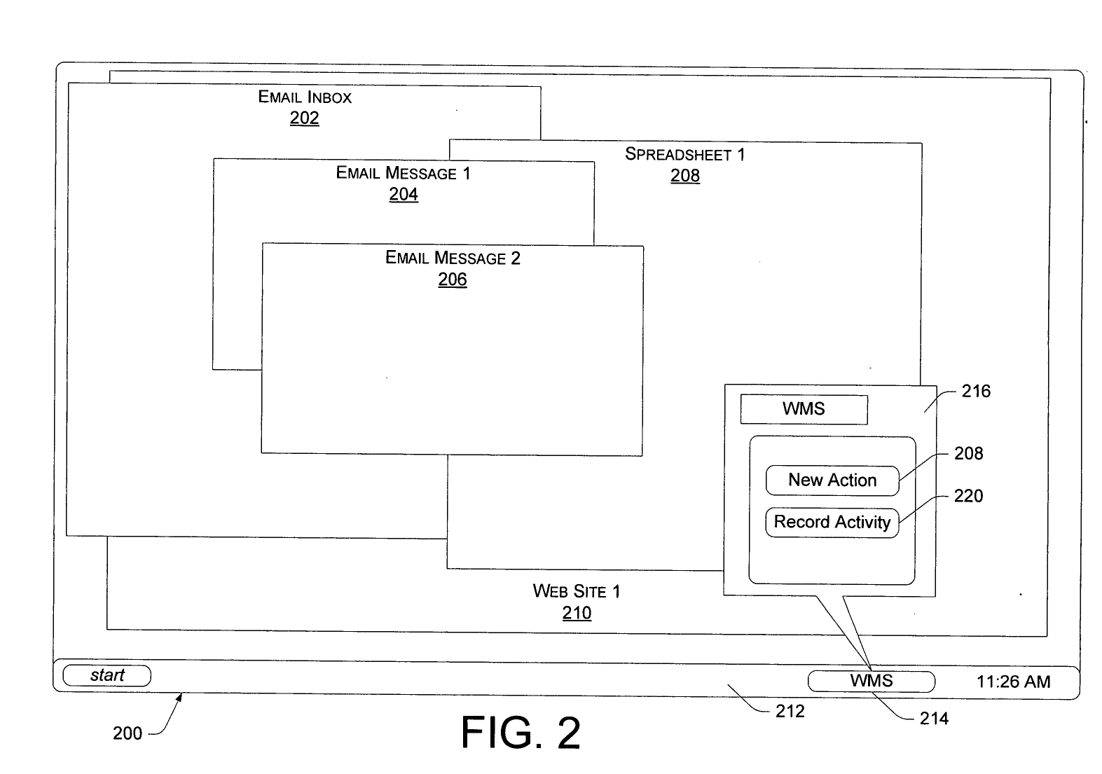

FIG. 2 is a simplified illustration of an exemplary user interface 200 in accordance with the present description. The exemplary user interface 200 is shown in a state that might result from a user's working experience since, typically, users will have multiple tiles open for one or more applications.

The exemplary user interface 200 includes tiles for an email inbox 202, a first email message (“email message 1” 204) and a second email message (“email message 2” 206). The exemplary user interface 200 also includes tiles for a spreadsheet (“spreadsheet 1” 208) and a web site (“web site 1” 210).

A tool bar 212 is included in the exemplary user interface 200 and includes a work management system (“WMS”) button 214. When the WMS button 214 is actuated as shown, a WMS tile 216 appears on the exemplary user interface 200. It is noted that the WMS button may be any type of actuator that, when actuated, initiates at least a portion of the framework described herein. Such an actuator has been labeled “WMS” herein merely for convenience and discussion purposes only.

The WMS tile 216 may include any practical number of actuators that provide miscellaneous work management processes to a user. In the present example, the WMS tile 216 includes a “New Action” actuator 218 and a “Record Activity” actuator 220. The “Record Activity” actuator 220 can be actuated by the user if the user wants his work activities tracked for possible inclusion in a new or existing action. Once actuated, the “Record Activity” actuator 220 causes one or more system modules to track work activity performed by the user. Such tracking is described in greater detail below, with respect to subsequent figures.

When the described framework is initially installed on a system, a user has an option to automatically track work activity. If this option is selected or if it is provided as a default option, the user's work is automatically tracked from a time the user begins work and for a period that is either predefined or set by the user. For example, a system may be configured to track an immediately previous thirty minutes of work. If this is the case, then if the user decides to create a new action object from his work or add his work to a pre-existing action object, the work tracked in the thirty minutes immediately preceding an indication from the user to save the tracked work will be associated with an identified action object.

Tracking a user's work activity and providing a user with the ability to create a new action object from tracked work resembles the practical manner in which many projects are initiated in the workplace. If a user is working on one or more tasks and subsequently decides that the work should be saved as an action object, the user selects the “New Action” actuator 218 to associate all open work items with a new action object.

Further aspects of the user interface 200 and its components are described in greater detail below, with respect to subsequent figures.

Exemplary User Interface—New Action Object Creation

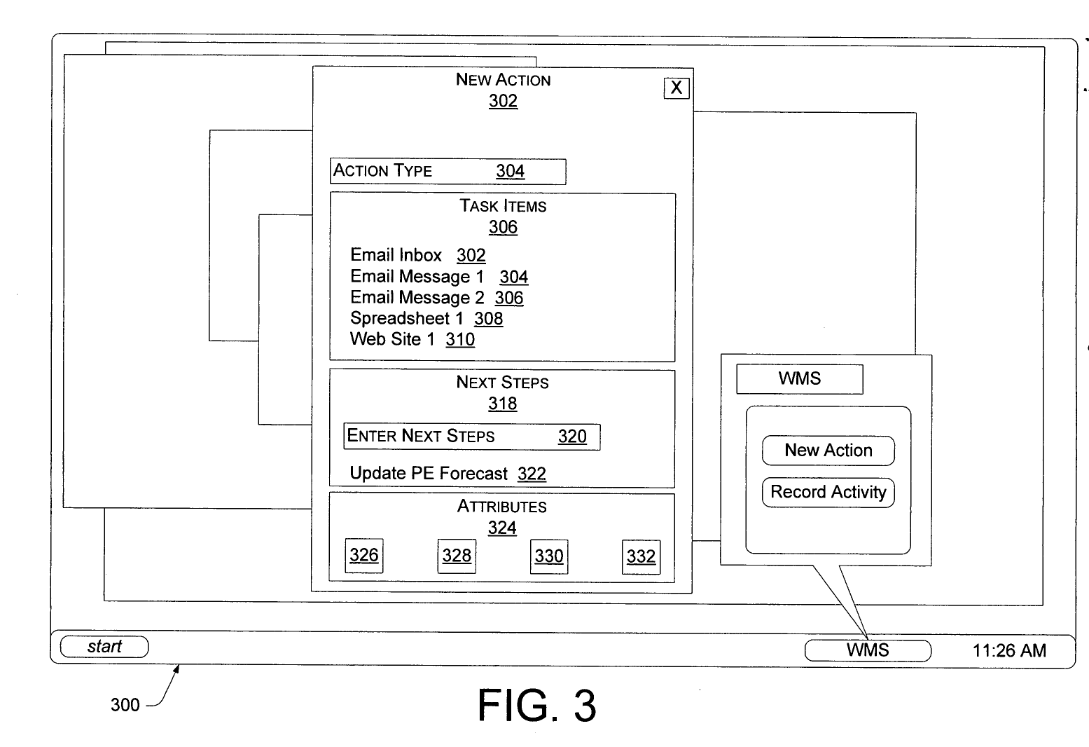

FIG. 3 is a simplified illustration of an exemplary user interface 300 (similar to the user interface 200 shown in FIG. 2) showing creation of a new action object. In response to a user actuating the “New Action” actuator 218 (FIG. 2), a “New Action” tile 302 appears on the user interface 300. It is noted that the “New Action” tile 302 shown in FIG. 3 is exemplary only and that any components shown may be omitted from a particular implementation. Conversely, other implementations may include one or more other components that are not shown in FIG. 3.

The “New Action” tile 302 is shown having an “Action Type” field 304 in which a particular type of action may be entered. Action objects may have a type associated with them and the type can be used for sorting and searching processes. For example, an action object may have a type “Patent Application.” Action objects of type “Patent Application” are related to patent applications and may include links to several document templates, contacts, etc. If an action object template exists for a particular action object type, then attributes and metadata associated with the action object template may be included with any action object created that has the same action type.

The “New Action” tile 302 also includes a task item field 306 that shows tasks items 308-316 that are currently associated with the new action object being created. The task items 308-316 shown in the present example (from FIG. 2) include: email inbox 202 (i.e. email application); email message 1 204; email message 2 206; spreadsheet 1 208; and web site 1 210. These are the task items that the user was working on (i.e. “current task items”) when the user decided to save the task items in an action object. Any other tracked task items—i.e. task items worked on by the user during the tracking period but not open at the time user initiated creation of the new action object—would also be included in the task item field 306.

In one or more implementations, the task items 202-210 included in the task item field 306 are selectable so that the user may choose to include or omit a particular task item from the action object. For example, the user in the present example may wish to omit web site 1 210 from the new action object. Depending on the configuration and whether it presents the selectable task items 202-210 as already selected or not selected, the user will either de-select or select the web site 1 210 task item.

When a task item 202-210 is selected from the task items field 306, a link to the task associated with the task item is added to new action object. If current tasks are to be associated with a current action object, then the links to the task items are added to the existing action object. By including links to tasks instead of the tasks themselves, memory is conserved and the tasks can reside in their original space and be linked to by one or more other users.

The “New Action” tile 302 may also be configured to include one or more other features. In the present example, the “New Action” tile 302 includes a “Next Steps” tile 318 where a user may keep track of other tasks associated with the new action object that the user needs to begin, schedule, complete, etc. An “Enter Next Steps” field 320 is provided to allow the user to enter other tasks related to the new action object. In this particular example, a step identified as “Update PE Forecast” 322 is shown. This indicates that a user has entered this as a task to begin, schedule, complete, etc. as a part of the new action.

Another feature included in the “New Action” tile 302 as shown is an “Attributes” tile 324. The “Attributes” tile 324 may include information related to the new action object and/or represent links, information, etc. that the user may associate with the new action object. In the present example, the “Attributes” tile 324 includes multiple configurable attribute icons 326-332.

The attribute icons 326-332 can be configured to represent virtually anything—metadata, tools, processes, etc.—that a user may find helpful in creating a new action object. For example, attribute icon 326 may be an icon that represents a personal digital assistant (PDA) (not shown). By clicking on such an attribute icon 326, a user may associate the new action object with the user's PDA so that the action object and its links can be accessed from the PDA.

In other example, attribute icon 326 may be an icon that represents a mobile telephone (not shown). Clicking on the attribute icon 326 would associate data related to the user's mobile telephone with the action object. For example, a user may simply configure the attribute icon to include one or more telephone numbers with the action object when the attribute icon 326 is actuated.

Other attribute icons 326-332 may be configured to represent virtually any attribute when actuated such as a category, importance, time frame, etc. It is noted that the above descriptions are exemplary only and are not exhaustive of the numerous possibilities that are configurable for the attribute icons 326-332.

Exemplary User Interface—Collateral Task Items

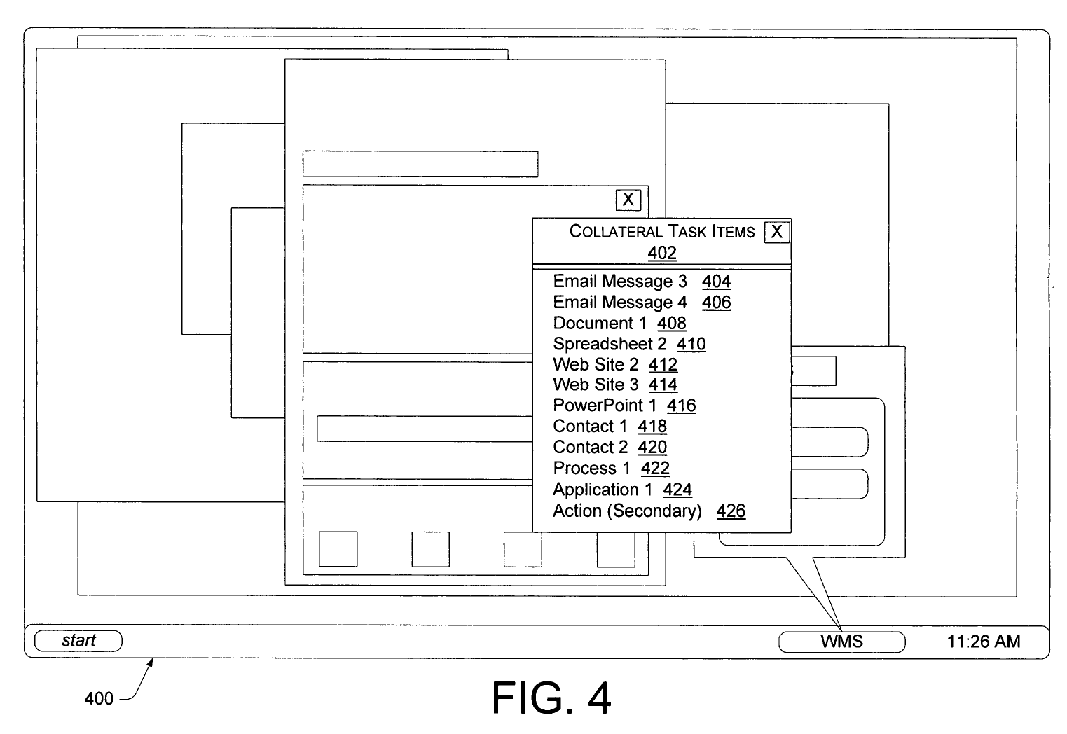

FIG. 4 is a simplified illustration a user interface 400 similar to the user interface 300 shown in FIG. 3 and further showing selectable collateral task items in a “Collateral Task Item” tile 402. The “Collateral Task Item” tile 402 appears after a user has finished associating task items with an action object via the “New Action” tile 302 (FIG. 3).

Task items that appear in the “New Action” tile 302 are items directly related to the new action object, i.e. tasks that the user is currently working on. Collateral task items that appear in the “Collateral Task Item” tile 402 are tasks that are related to task items that the user includes in the action object.

In order to assist a user in organizing tasks, collateral task items—such as contacts, files, documents, and the like—are presented to a user when the user creates an action object. A system can be configured to infer which collateral task items might be of interest to a user and to present these collateral task items to the user. The user may then select or ignore any or all of the presented collateral task items, depending on whether the user wants the collateral task items to be associated with the action object.

In the present example, the “Collateral Task Item” tile 402 includes “Email Message 3” 404, “Email Message 4” 406, “Document 1” 408, “Spreadsheet 2” 410, “Web Site 2” 412 and “Web Site 3” 414. This indicates that selection of any of these collateral task items will include the collateral task item as a task item in the new action object.

The “Collateral Task Item” tile 402 also includes “PowerPoint 1” 416, “Contact 1 ” 418, “Contact 2” 420, “Process 1 ” 422, “Application 1 ” 424 and “Action (Secondary)” 426. “Action (Secondary)” is another action object that may be referenced as a task item by the new action object. Action objects may be nested in such a manner to any practical number of levels.

Although certain types of collateral task items have been identified (documents, spreadsheets, contacts, web sites, etc.), it is noted that task items and collateral task items may be linked to virtually any electronic file, including digital photographs, live camera feeds, and the like.

There are several ways in which a system may infer which task items may be appropriate to present as collateral task items. One way is to identify all task items associated with action objects having a same type as a current action object. For example, if the user is creating an action object having a type “Patent Application,” collateral task items that could be identified for presentation to the user could be any task item associated with any other action object of type “Patent Application.”

Another way to that collateral task items may be identified is to identify task items from other action objects that are similar to task items of the current action object. For example, if a task item from a current action object is an email message to “billg”, then a system may be configured to present all email messages to “billg” from other actions. The user can then select any such email message that the user wishes to associate with the current action.

Any other intuitive method may be implemented to identify collateral task items that a user may wish to include as task items with a current action object.

Exemplary User Interface: Dynamic Prioritization

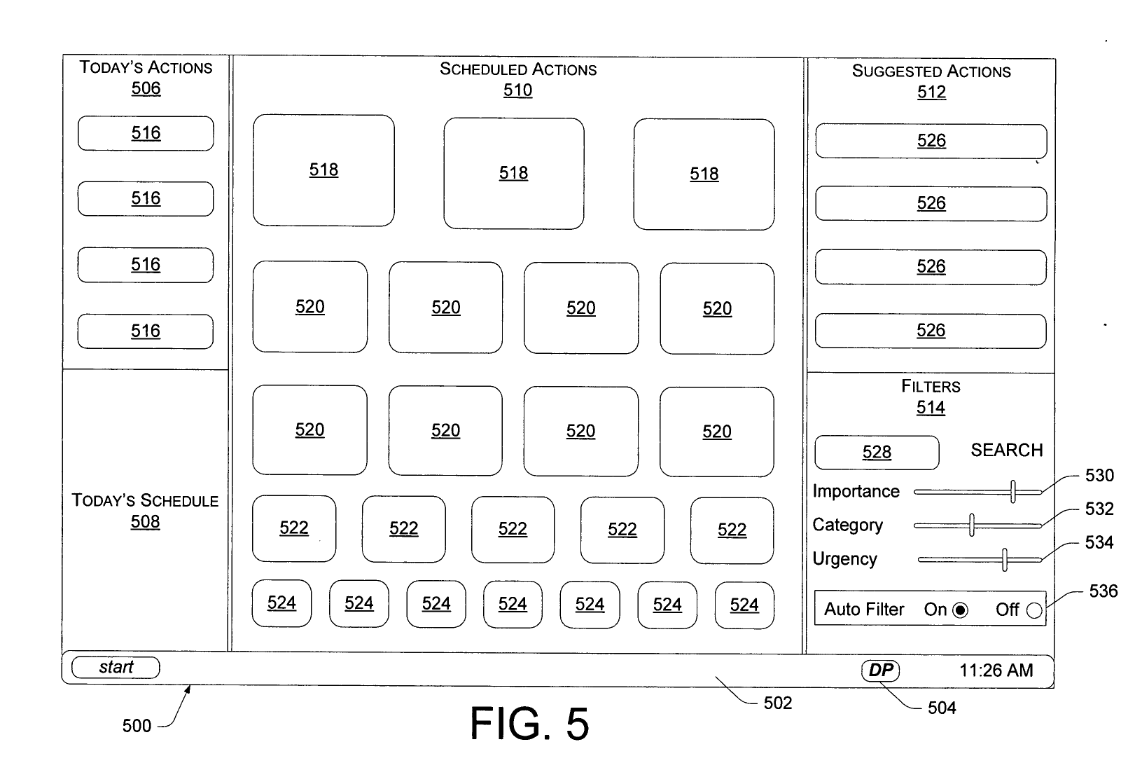

FIG. 5 is a simplified illustration of an exemplary user interface 500 for dynamic prioritization of actions in a work management process. Although particular elements are shown in the exemplary user interface 500, the elements are shown collateral to, and as an example of, one particular implementation of dynamic prioritization as described herein. Other implementations may only have some similar elements as shown in FIG. 5 or no similar elements. Furthermore, any similar elements in one or more other implementations may be arranged differently than the elements shown in FIG. 5 or may contain additional elements than are shown herein. In the following discussion, continuing reference is made to reference numerals and elements shown and described with respect to previous figures.

The exemplary user interface 500 includes a toolbar 502 and an actuatable dynamic prioritization (“DP”) icon 504 that, when actuated, presents the exemplary user interface 500. Like other application icons, the DP icon 504 may be presented on a user interface desktop in addition to or instead of on the toolbar 502. Additionally, other icon styles may be associated with a dynamic prioritization process.

The exemplary user interface 500 also includes a “Today's Actions” tile 506, a “Today's Schedule” tile 508, a “Scheduled Actions” tile 510, a “Suggested Actions” tile 512 and a “Filters” tile 514. The “Today's Actions” tile 506 lists one or more actions 516 that a user has on a current schedule.

Each of the actions 516 shown in the “Today's Actions” tile 506 displays text, graphics or a combination of the two, that identify a substance of the action associated therewith. For example, an action 516 may include the text “Prepare Quarterly Financial Statement.” In addition, an action 516 may include additional subtext that relates to the action. For example (and depending on the specific implementation), such subtext may identify one or more task items (FIG. 3, 306) associated with the action 516, such as contacts (persons who may need to be contacted to perform the action), etc.

The “Today's Schedule” tile 518 displays a more detailed schedule according to time slots identifying which actions 516 are scheduled for which time slots. For example, a time slot from 8 a.m. to noon may be allotted for the action “Prepare Quarterly Financial Statement”. The “Today's Schedule” tile 518 may be similar to familiar calendars currently in use.

The “Scheduled Actions” tile 510 includes up to all actions 518-524 that are owned by the user. The “Scheduled Actions” tile 510 may be configured to only display a certain number of actions or as many actions that will fit in the tile 510. In at least one implementation, the actions 518-524 denote an analog prioritization, i.e., certain actions are larger and are shown above other actions. In the present example, actions 518 take precedence over actions 520, which take precedence over actions 522, which take precedence over actions 524. The basis for such prioritization is determined dynamically as described herein. The actions 518-524 in the “Scheduled Actions” tile 510 may be dragged into the “Today's Actions” tile 506 if the user wants to re-schedule a particular action for today. Similarly, actions 516-524 may be dragged to another location within the same tile to manually rearrange priority and/or a schedule.

The “Suggested Actions” tile 512 includes suggested actions 526 that are provided to the user in certain circumstances. For example, a user may request a system to provide the suggested actions 526 to the user. In at least one implementation, the suggested actions 526 are provided to the user upon the occurrence of a time slot becoming available due to a cancellation or a re-scheduling. The manner in which the suggested actions 526 are derived are described in greater detail below.

The “Filters” tile 514 contains a variety of filter settings/functions that the user may adjust to focus a search for suggested actions. The settings and functions shown are exemplary in nature and are not meant to represent an exhaustive sample of elements that may be included in the “Filters” tile 514.

The “Filters” tile 514 includes a search field 528 in which a user may enter one or more search terms. This is similar to familiar search functions known in the art. The user enters a word or phrase and action objects that match the word or phrase are returned. However, with dynamic prioritization, the action objects that are returned in response to a search may be further winnowed by previously entered filters or by automatically generated filters. Such filters are discussed below, with reference to other elements included in the “Filters” tile 512.

The “Filters” tile 512 also includes an “Importance” slider 530, a “Category” slider 532 and an “Urgency” slider 534. The sliders 530-534 are configurable so that other attributes may be represented by the sliders 530-534. Any attribute that a user deems applicable to the user's work may be included, such as an attribute that indicates a time frame within which the action is to be completed.

Setting a slider 530-534 to a higher level means that more weight is given to action objects having the slider attribute in the search process. For example, if an importance attribute is set to a high level, then more weight is given to actions objects having a higher importance attribute (e.g. high) than to action objects having a lower importance attribute (e.g. average).

An auto filter selector 536 is also included in the “Filters” tile 512. The sliders 530, 532, 534 and the auto filter selector 516 may be used in conjunction with the search field 528 or with each other to better determine actions having priority. An automatic filter generator feature can be turned on or off using the auto filter selector 536. When the automatic filter generator feature is turned on, a user is requesting that the system use stored usage patterns to determine a set of suggestions to provide to the user.

For example, a system may track a user's work habits and conclude that a user typically works on actions that are due the next day. Hence, when searching for suggested actions, the system will assign a higher significance to actions due the next day. The automatic filter generation process is described in greater detail below.

Exemplary Computing System

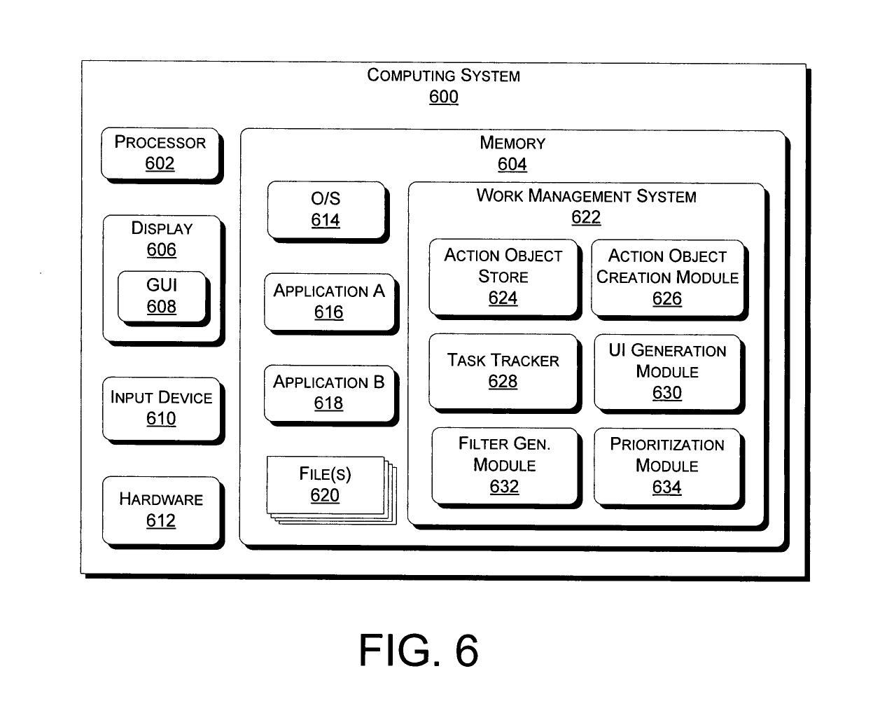

FIG. 6 is a block diagram of an exemplary computing system 600 in accordance with the present description. Although the exemplary computing system 600 includes various elements arranged in a particular manner and more or less particular functionality is attributed to the various elements below, it is noted that a computing system in accordance with the present description may have more or fewer and/or different elements, which may be distributed in a different arrangement than is shown herein. In addition, similar elements in one or more other implementations of a computing system in accordance with the present description may have functions similar but not identical to those described below, and said functions may be distributed differently among the different elements without departing from the scope of the subject matter claimed herein.

The exemplary computing system 600 includes a processor 602, memory 604 and a display 606 configured to display a graphical user interface 608 that is similar to the user interfaces described in relation to FIGS. 2-5. The exemplary computing system 600 also includes an input device 610, such as a mouse, stylus or the like, and other miscellaneous hardware 612 that may be found in typical computing systems and necessary to carry out the functionality described herein.

The memory 604 is shown storing an operating system 614 that controls the basic operations of the exemplary computing system 600 and miscellaneous other functions. The memory 604 is also shown with a first application (“Application A” 616), a second application (“Application B” 618), and one or more files 620 stored therein. Application A 616 and Application B 618 are processor-executable applications that may be used in accomplishing tasks as described herein. Such applications may include, but are not limited to word processing applications, spreadsheet applications, contact applications, email applications, electronic presentation applications, web browsers, etc.

The one or more files 620 are electronic files that are associated with various elements of the computing system 600, such as one or more email message files that are associated with Application A 616 (an email application in the immediate example). Although shown stored separately from the applications, the files may also be considered to reside within one or more application.

The memory 604 also includes an exemplary work management system 622 configured to carry out at least most of the functionality described herein. The exemplary work management system 622 includes an action object store 624 that can contain action objects (FIG. 1, 102) and/or action object templates (FIG. 1, 104). An action object creation module 626 is also included in the exemplary work management system 622 and is configured to create and/or modify action objects (not shown) in the action object store 624.

The exemplary work management system 622 includes a task tracker 628 that is configured to track tasks performed on the computing system 600. As previously described, tasks performed by a user can be tracked (by the task tracker 628) so that they can be included in an action object if and when the user decides that his work should be associated with an action object. The task tracker 628 also tracks/locates collateral task items as well as states and processes currently in effect on the exemplary computing system 600.

The task tracker 628 is also configured to track a user's work habits for use in conjunction with a filter generation module 630 that generates search filters from attributes, metadata and tracked work habits. The following are examples of user work habits that may be tracked: due dates of actions worked on; whether due dates in particular categories are normally hard dates or whether than can slide; urgency, importance, personal criteria (e.g. effort level, interest level, etc.) of actions worked on most; and the like.

The graphical user interface 608 is generated by a user interface (UI) generation module 632 that is included in the exemplary work management system 622. The UI generation module 632 includes computer-executable instructions that are executable on the processor 602 and that, when executed, cause the graphical user interface 608 to be displayed on the display 606. The UI generation module 632 may also be configured to identify and accept input from a user to one or more other modules of the exemplary computing system 600.

The work management system 622 also includes a prioritization module 634 that is configured to determine priority of a user's actions when requested by a user (e.g. “What should I work on now”) or when a particular event is detected (e.g. when a scheduled action is canceled and time becomes available on a user's calendar).

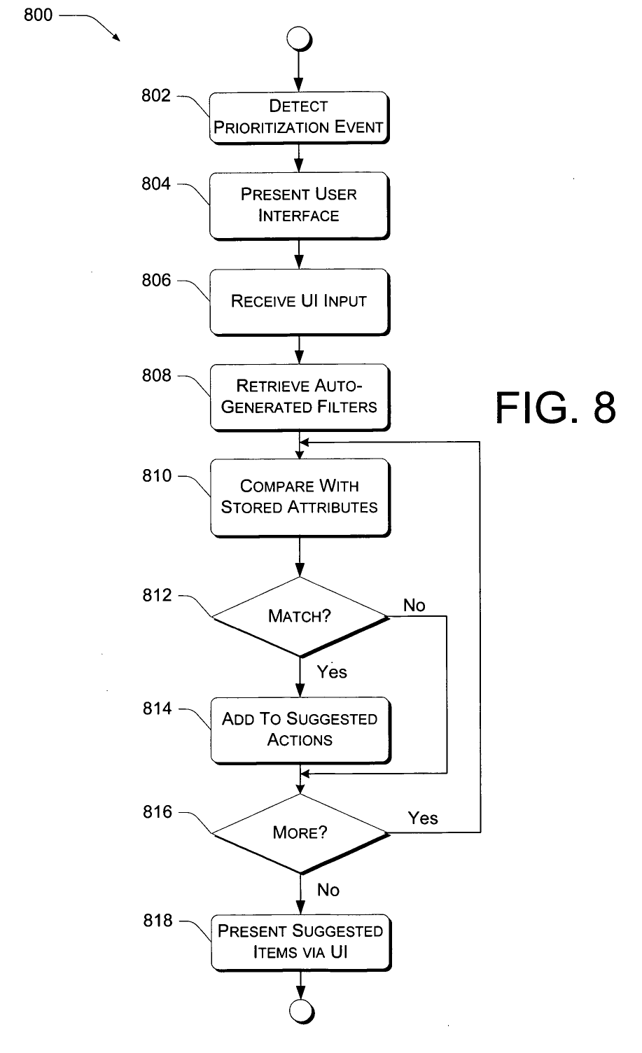

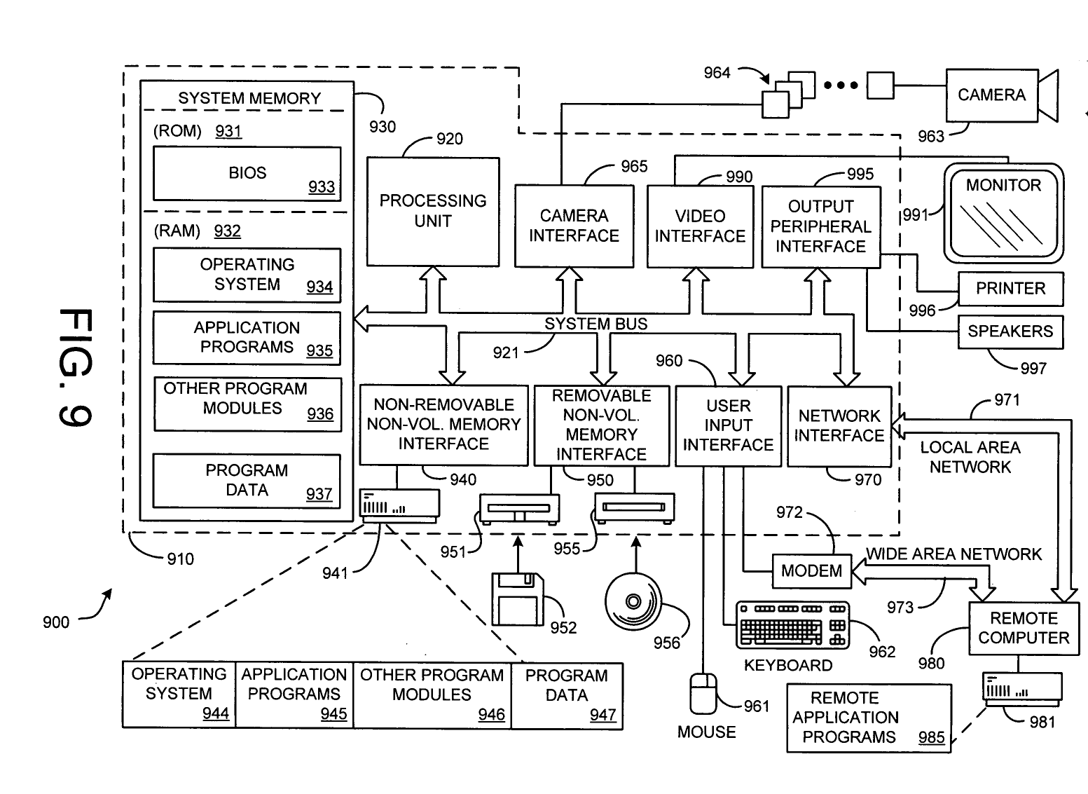

Functional aspects of the computing system 600 and its elements—particularly the filter generation module 630 and the prioritization module 634—are discussed in greater detail below, with respect to the flow diagrams shown in FIG. 8 and FIG. 9.

Exemplary Methodological Implementation: Work Tracking

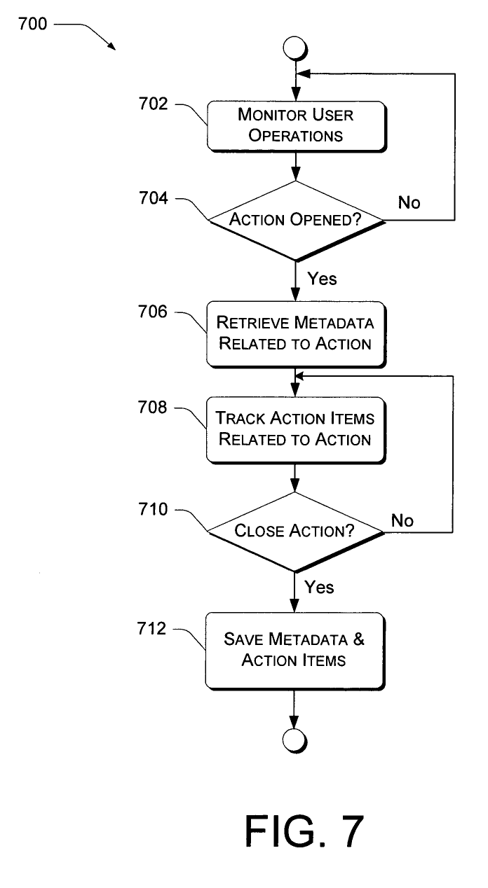

FIG. 7 is a flow diagram 700 depicting an exemplary methodological implementation of a work tracking process in accordance with the present description. In the following discussion, continuing reference is made to elements and reference numerals shown in one or more previous figures. It is noted that the steps presented in the following exemplary methodological implementation may be performed alone or in conjunction with one or more other steps and that the steps may not necessarily be performed in the particular order shown below.

At block 702, the task tracker 624 monitors user activities to determine, inter alia, when the user opens an action. The user's activities are tracked until a user opens an action, either by retrieving a stored action object 102 (FIG. 1) or by creating a new action object (see FIG. 2-FIG. 4). The user's activities continue to be monitored as long as no action is opened (“No” branch, block 704). When an action is opened (“Yes” branch, block 704), metadata associated with the action object is retrieved at block 706).

Metadata, for purposes of this discussion, includes all data associated with the action object as shown in FIG. 1 (members, state information, attributes, links, user definitions, etc.). In particular, it is significant that beginning state information and ending state information is retrieved, tracked, stored, etc. for one or more of the functional aspects of dynamic prioritization.

For instance, one attribute that is used in dynamic prioritization is a “time to complete” attribute. In at least one implementation, a “time to complete” attribute changes each time the user works on an action. If an action requires two hours to complete and the user works on the action for one hour, then the “time to complete” the action will change to one hour.

In the case that the newly opened action object is a stored action object 102 from the action object store 100 (FIG. 1), the metadata that is retrieved is any metadata that has been stored with the action object. In the case that the action object is a newly created action object, then the metadata is that metadata that has been associated with the action object from prior tracking of user activities. In at least one implementation, recently tracked items may also be added to a stored action object. In such an implementation, the metadata is a combination of metadata retrieved from the action object store 100 and metadata obtained from tracking user activities.

After the stored and/or current metadata is retrieved, the task tracker 624 tracks all or certain work activities (i.e. task items) across multiple applications as the user works (block 708). This tracking continues as long as the action is not closed (“No” branch, block 710). When the action is closed (“Yes” branch, block 710), the metadata and tracked items are saved with the action object in the action object store 100.

Exemplary Methodological Implementation: Dynamic Prioritization

FIG. 8 is a flow diagram 800 depicting an exemplary methodological implementation of dynamic prioritization in a work management process in accordance with the present description. In the following discussion, continuing reference is made to elements and reference numerals shown in one or more previous figures. It is noted that the steps presented in the following exemplary methodological implementation may be performed alone or in conjunction with one or more other steps and that the steps may not necessarily be performed in the particular order shown below.

At block 802, the prioritization module 634 detects a prioritization event. The work management system 622 continuously monitors for such events, which can be designated as any of a number of particular occurrences. One example of a prioritization event is when a user submits a request to the work management system 622 to suggest actions that the user can work on to make the best use of the user's time. Another example is when a scheduled action is cancelled, at which point the system 622 may query the user as to whether the user wants to schedule another action for the newly vacated time slot. Other specific situations may be identified to be prioritization events for purposes described herein.

At block 804, the user interface generation module 630 presents the graphical user interface 608 to the user via the display. The particular user interface can be the user interface 500 shown and described in FIG. 5 and further discussion assumes utilization of the user interface 500.

When presented with the user interface 500, the user is free to begin the prioritization based on current filter settings or to adjust filter settings to suit the user's immediate requirements. As previously discussed, the user can see his current scheduled, actions currently scheduled, the most important of his scheduled actions and one or more filter options.

The user may want to enter a search term in the search field 528 to find actions related to a particular matter or person. Or the user may adjust the sliders 530-534 to place emphasis on certain action attributes. For example, if the user wants to emphasize an action category in his search, the user can adjust the “Category” slider 532 to a maximum setting.

Although not shown here, other user controls may be utilized to customize search filters, such as icons that represent attributes that a user can include in a filter by actuating the icons. The user input, in whatever form it is made, is received by the prioritization module at block 806.

Automatically generated filter criteria are retrieved at block 808. This is data that is tracked to identify particular user work habits. For example, tracking a user's work habits may indicate that the user tends to work on actions that are due the following day. Or, such tracking may indicate that a user always works at least a certain amount of time on actions of a certain type. For example, if there is a “Draft Patent Application” action object type, the system may discern that the user always works in time increments of at least two hours. As a result, search filters would not likely suggest such an action type for a one hour time slot.

Any particular work habit that may be identified and associated with a user can be used in the automatically generated filters. This feature, as shown in the user interface 500, may be disabled by the user when the user wants to maintain manual control of the searching function.

Once all of the search criteria has been collected, the action objects 102 are filtered to determine which one or more, if any, can best fill an open time slot (block 810). Although this particular example deals with filling a vacant time slot, it is noted that an open slot is not necessary to take advantage of this feature. A user may ask for suggestions for actions that would best utilize the user's time at the moment, regardless of whether the user's calendar has an opening or not. This provides the user with a way to maximize efficiency in the event the user can replace an existing action with a more efficient one.

Any method known in the art for weighting the search may be used. Since different values are placed on different criteria/attributes, such a weighting technique is used to identify suggested actions.

When a match is found (“Yes” branch, block 812), the match is added to the suggested actions at block 814. If no match is found (“No” branch, block 812) and if there are more action objects to search (“Yes” branch, block 816), then the process repeats from block 810. When there are no action objects 102 left to search (“No” branch, block 816), the suggested actions are presented to the user via the user interface 500 (block 818).

The initial list of suggested actions presented to a user may be limited to a certain number of “best” matches. For example, the five best matching actions may be presented to the user as suggested actions. Alternatively, all of the matching actions may be presented to the user and then the user may adjust the filters again and perform the process outlined in flow diagram 800 on those suggested actions to get a narrower set of suggested actions.

When a user determines to take a suggested action 512 and adds it to the user's current work schedule, the user can drag and drop the suggested action 512 onto one or more of the other tiles of the user interface 500, such as the “Today's Actions” tile 506 and/or the “Today's Schedule” tile 508.

Exemplary Operating Environment

FIG. 9 is a block diagram depicting a general purpose computing environment 900 that may be used in one or more implementations according to the present description. The computing system environment 900 is only one example of a suitable computing environment and is not intended to suggest any limitation as to the scope of use or functionality of the claimed subject matter. Neither should the computing environment 900 be interpreted as having any dependency or requirement relating to any one or combination of components illustrated in the exemplary operating environment 900.

The described techniques and objects are operational with numerous other general purpose or special purpose computing system environments or configurations. Examples of well known computing systems, environments, and/or configurations that may be suitable for use include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The following description may be couched in the general context of computer-executable instructions, such as program modules, being executed by a computer. Generally, program modules include routines, programs, objects, components, data structures, etc. that perform particular tasks or implement particular abstract data types. The described implementations may also be practiced in distributed computing environments where tasks are performed by remote processing devices that are linked through a communications network. In a distributed computing environment, program modules may be located in both local and remote computer storage media including memory storage devices.

With reference to FIG. 9, an exemplary system for implementing the invention includes a general purpose computing device in the form of a computer 910. Components of computer 910 may include, but are not limited to, a processing unit 920, a system memory 930, and a system bus 921 that couples various system components including the system memory to the processing unit 920. The system bus 921 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 910 typically includes a variety of computer readable media. Computer readable media can be any available media that can be accessed by computer 910 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 910. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 930 includes computer storage media in the form of volatile and/or nonvolatile memory such as read only memory (ROM) 931 and random access memory (RAM) 932. A basic input/output system 933 (BIOS), containing the basic routines that help to transfer information between elements within computer 910, such as during start-up, is typically stored in ROM 931. RAM 932 typically contains data and/or program modules that are immediately accessible to and/or presently being operated on by processing unit 920. By way of example, and not limitation, FIG. 9 illustrates operating system 934, application programs 935, other program modules 936, and program data 937.

The computer 910 may also include other removable/non-removable, volatile/nonvolatile computer storage media. By way of example only, FIG. 9 illustrates a hard disk drive 941 that reads from or writes to non-removable, nonvolatile magnetic media, a magnetic disk drive 951 that reads from or writes to a removable, nonvolatile magnetic disk 952, and an optical disk drive 955 that reads from or writes to a removable, nonvolatile optical disk 956 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 941 is typically connected to the system bus 921 through anon-removable memory interface such as interface 940, and magnetic disk drive 951 and optical disk drive 955 are typically connected to the system bus 921 by a removable memory interface, such as interface 950.

The drives and their associated computer storage media discussed above and illustrated in FIG. 9, provide storage of computer readable instructions, data structures, program modules and other data for the computer 910. In FIG. 9, for example, hard disk drive 941 is illustrated as storing operating system 944, application programs 945, other program modules 946, and program data 947. Note that these components can either be the same as or different from operating system 934, application programs 935, other program modules 936, and program data 937. Operating system 944, application programs 945, other program modules 946, and program data 947 are given different numbers here to illustrate that, at a minimum, they are different copies. A user may enter commands and information into the computer 910 through input devices such as a keyboard 962 and pointing device 961, commonly referred to as a mouse, trackball or touch pad. Other input devices (not shown) may include a microphone, joystick, game pad, satellite dish, scanner, or the like. These and other input devices are often connected to the processing unit 920 through a user input interface 960 that is coupled to the system bus 921, but may be connected by other interface and bus structures, such as a parallel port, game port or a universal serial bus (USB). A monitor 991 or other type of display device is also connected to the system bus 921 via an interface, such as a video interface 990. In addition to the monitor, computers may also include other peripheral output devices such as speakers 997 and printer 996, which may be connected through an output peripheral interface 995. A camera 963 (such as a digital/electronic still or video camera, or film/photographic scanner) capable of capturing a sequence of images 964 can also be included as an input device to the personal computer 910. Further, while just one camera is depicted, multiple cameras could be included as an input device to the personal computer 910. The images 964 from the one or more cameras are input into the computer 910 via an appropriate camera interface 965. This interface 965 is connected to the system bus 921, thereby allowing the images to be routed to and stored in the RAM 932, or one of the other data storage devices associated with the computer 910. However, it is noted that image data can be input into the computer 910 from any of the aforementioned computer-readable media as well, without requiring the use of the camera 963.

The computer 910 may operate in a networked environment using logical connections to one or more remote computers, such as a remote computer 980. The remote computer 980 may be a personal computer, a server, a router, a network PC, a peer device or other common network node, and typically includes many or all of the elements described above relative to the computer 910, although only a memory storage device 981 has been illustrated in FIG. 9. The logical connections depicted in FIG. 9 include a local area network (LAN) 971 and a wide area network (WAN) 973, but may also include other networks. Such networking environments are commonplace in offices, enterprise-wide computer networks, intranets and the Internet.

When used in a LAN networking environment, the computer 910 is connected to the LAN 971 through a network interface or adapter 970. When used in a WAN networking environment, the computer 910 typically includes a modem 972 or other means for establishing communications over the WAN 973, such as the Internet. The modem 972, which may be internal or external, may be connected to the system bus 921 via the user input interface 960, or other appropriate mechanism. In a networked environment, program modules depicted relative to the computer 910, or portions thereof, may be stored in the remote memory storage device. By way of example, and not limitation, FIG. 9 illustrates remote application programs 985 as residing on memory device 981. It will be appreciated that the network connections shown are exemplary and other means of establishing a communications link between the computers may be used.

### CONCLUSION

While one or more exemplary implementations have been illustrated and described, it will be appreciated that various changes can be made therein without departing from the spirit and scope of the claims appended hereto.

1. A method, comprising:
detecting a prioritization event;
generating a search filter based on available resources and a user work history;
using the search filter to identify, from a set of action objects, a subset of one or more action objects that are substantially in accordance with the user work history and are accommodated by the available resources;
presenting the subset of action objects to the user via a user interface as selectable suggested actions;
receiving user input selecting one or more of the suggested actions for inclusion into a user work schedule; and
incorporating user selected suggested actions into the user work schedule.

2. The method as recited in claim 1, wherein the detecting a prioritization event further comprises detecting when a time slot in the user work schedule becomes available.

3. The method as recited in claim 1, wherein the detecting a prioritization event further comprises detecting a user request for prioritization.

4. The method as recited in claim 1, further comprising tracking the user's work to derive the user work history.

5. The method as recited in claim 1, wherein the generating a search filter further comprises receiving user input identifying one or more search terms.

6. The method as recited in claim 1, wherein the generating a search filter further comprises receiving user input assigning a weight to one or more search terms.

7. A work management system, comprising:
memory;
a processor;
a prioritization module configured to search a plurality of action objects for one or more action objects that substantially match to a time period based on action object attributes and resources available for the time period; and
a user interface configured to present the one or more matching action objects to a user and accept selection input from the user to identify at least one matching action object to be scheduled for the time period.

8. The work management system as recited in claim 7, further comprising a filter generation module configured to create a search filter for use by the prioritization module by identifying attributes, user work history and user input to be used in the search.

9. The work management system as recited in claim 8, wherein the user input identifies one or more search terms.

10. The work management system as recited in claim 8, wherein the user input further comprises assigning a weight to one or more search terms.

11. The work management system as recited in claim 7, further comprising a task tracker configured to track a user's work history regarding actions the user works on and in relation to one or more calendar events associated with the actions.

12. The work management system as recited in claim 7, wherein the prioritization module is further configured to detect a prioritization event that initiates the search.

13. The work management system as recited in claim 12, wherein the prioritization event further comprises a user request to initiate the search.

14. The work management system as recited in claim 12, wherein the prioritization event further comprises a change in a user work schedule.

15. One or more computer-readable media containing executable instructions that, when executed, perform the following steps:
searching a plurality of action objects to identify one or more action objects that describe an action suitable for inclusion in a calendar time slot based on action object attributes, user input and tracked properties;
presenting the matching one or action objects in a user interface as selectable user interface elements; and
receiving selected action objects for inclusion in the calendar time slot.

16. The one or more computer-readable media as recited in claim 15, further comprising the step of receiving user input that assigns a search weight to one or more search terms.

17. The one or more computer-readable media as recited in claim 15, further comprising the step of receiving one or more search terms from user input.

18. The one or more computer-readable media as recited in claim 15, further comprising detecting a prioritization event and performing the search in response to the detection.

19. The one or more computer-readable media as recited in claim 18, wherein the prioritization event further comprises the time slot being identified as being available.

20. The one or more computer-readable media as recited in claim 18, wherein the prioritization event further comprises a request from the user to perform the search.
